(19) United States
(12) Patent Application Publication
(10) Pub. No.: US 2017/0078452 A1
(43) Pub. Date: Mar. 16, 2017

(54) WEB NATIVE BRIDGE

(71) Applicant: Optum, Inc., Minnetonka, MN (US)

(72) Inventors: Joost Verrijt, Den Bosch (NL); Brian Singer, Farmington Hills, MI (US); Matthew McGoogan, Denver, CO (US); Chris Bellinger, East Lansing, MI (US)

(73) Assignee: Optum, Inc., Minnetonka, MN (US)

(21) Appl. No.: 15/309,284

(22) PCT Filed: May 7, 2014
(86) PCT No.: PCT/US14/37127

§ 371 Date: Nov. 7, 2016

(51) Int. Cl. H04L 29/06; H04L 29/08; G06F 9/54

(52) U.S. Cl. CPC H04L 67/42; G06F 9/547; H04L 67/02; G06F 8/30

(57) ABSTRACT

An HTTP web-native bridge includes an HTTP server that exposes native mobile modules through a RESTful web service. A full HTTP feature set may be utilized to interact with the native mobile modules to access native features and functionalities of a mobile device by a web service. The HTTP web-native bridge may be implemented without including additional libraries in the web service code or requiring web service developers to write application programming interface code.

### FIELD OF TECHNOLOGY

The present disclosure relates generally to mobile application development and particularly to systems and frameworks for developing hybrid mobile applications.

### BACKGROUND

Software applications for mobile computing devices, which are commonly referred to as “apps,” include native applications, mobile web applications and hybrid applications. Native applications for mobile devices are generally developed in computer code that is compiled and configured to be executed directly by a processor that is incorporated in the mobile device.

Native applications are generally developed using a platform-specific software development kit (SDK) and are generally written as native code in platform-specific computer languages. The platform-specific SDK is generally provided to developers by the platform vendor. For example, native applications for an iOS platform such as an iPhone or iPad by Apple Inc. of Cupertino, Calif. are developed using an iOS SDK and Xcode Integrated Development Environment (IDE), which are provided to developers by Apple Corporation. The Xcode SDK facilitates programming in the Objective-C programming language. Similarly, applications for Android platforms, a product of Google Inc. of Mountain View, Calif., are generally developed in the Java programming language using the an Android SDK, which is provided to developers by Google Corporation. Applications for the Windows Phone platform by Microsoft Corporation of Redmond, Wash., are generally developed in the C# programming language using a Windows Phone SDK in Microsoft's Visual Studio IDE.

Mobile web applications are server-side applications, which may be built using well-known server-side technologies such as PHP, Node.js and ASP.NET, for example. PHP is a server-side scripting language for web development, which may also be used as a general-purpose programming language. Node.js is a software platform for running server-side and networking applications written in JavaScript. ASP.NET is a server-side web application framework for developing dynamic web sites, web applications and web services. The various server side technologies may be used to generate code such as hypertext markup language code (HTML) that has been styled to render well on a mobile device form factor.

Hybrid mobile applications are applications that are written for mobile devices using web technologies such as HTML5, CSS and JavaScript. However, unlike mobile web applications, which are executed on a server, hybrid applications are executed on the mobile device. The hybrid applications may run within a native container, in which the web technologies are interpreted by lower level native coded applications. For example, hybrid applications may be executed on a mobile device by a browser engine of the mobile device to render HTML. Hybrid application code such as JavaScript may be processed locally by the browser engine without accessing the device's browser to communicate with a server.

Because hybrid applications and web applications are developed using web based languages such as Java Script and HTML, which are high level interpretive codes, they do not have as much control of device hardware as compiled native applications. Therefore, hybrid applications and web applications may not be able to exploit certain features and functionalities of a mobile device, such as a camera, a phone, an accelerometer, a global positioning system (GPS), audio services, or local storage, for example.

Mobile device platform vendors traditionally provide tools for web developers to bridge the gap between web application programming environments and native platform programming environments in order for web applications to access certain lower level functionalities of a device. In order to use the platform-specific tools web developers need to acquire expert knowledge of the platform vendor's development resources and learn how to properly merge native code with a web application.

Well known open source development tools and frameworks, such as PhoneGap, provide a bridge between web applications and native device platforms that allow access to the native features of a mobile device using HTML, CSS and JavaScript. Such development tools and frameworks generally provide client libraries and/or client APIs that need to be included within a web application require developers to write framework-specific functions to access the native features of the mobile device. Thus, web developers need to acquire certain specific expert knowledge to incorporate the client libraries and APIs within web applications and to write the framework-specific code to access native features and functionalities of a mobile device. Moreover, applications that are developed by implementing the previous bridge frameworks include the libraries and APIs within web applications and may therefore be larger and slower than native code.

### SUMMARY

An aspect of the present disclosure include a method for accessing native features of a computing device. According to this aspect, the method includes receiving a hypertext transfer protocol (HTTP) request from a client application for access to a native feature of the computing device by an HTTP server and identifying a previously stored native code by the HTTP server in response to receiving the HTTP request. The identified previously stored native code is executable by the computing device to access the native feature. The method also includes executing the previously stored native code on the device to access the native feature, receiving a reply of the native feature by the server and generating an HTTP reply by the HTTP server. The HTTP reply includes information contained in the reply of the native feature.

A method for accessing native features of a mobile computing device according to another aspect of the present disclosure includes sending a hypertext transfer protocol (HTTP) request to an HTTP server on a mobile computing device. The HTTP request requests access to a native feature of the mobile computing device. The method also includes receiving an HTTP reply from the HTTP server. The HTTP reply is generated by the HTTP server and includes information contained in a reply of the native feature in response to implementation of the native feature.

Another aspect of the present disclosure includes an apparatus for accessing native features of a computing device. According to this aspect, the apparatus includes means for receiving a hypertext transfer protocol (HTTP) request from a client application for access to a native feature of the computing device and means for identifying a previously stored native code in response to receiving the HTTP request. The identified previously stored native code is executable by the computing device to access the native feature. The apparatus also includes means for executing the previously stored native code on the device to access the native feature, means for receiving a reply of the native feature by the server and means for generating an HTTP reply. The HTTP reply includes information contained in the reply of the native feature.

An apparatus for accessing native features of a mobile computing device according to another aspect of the present disclosure includes a server configured for receiving a hypertext transfer protocol (HTTP) request from a web client application for access to a native feature of the mobile computing device. The server includes a RESTful application programming interface. The apparatus also includes memory in communication with the server. The memory stores previously written native code of the mobile computing device to access the native feature. According to this aspect, a native process of the device is in communication with the server and is configured to execute the native code to implement the native feature.

These and other features and advantages of the present invention will become apparent from the following detailed description of illustrative embodiments thereof, which is to be read in connection with the accompanying drawings.

### BRIEF DESCRIPTION OF THE DRAWINGS

A more complete understanding may be derived by referring to the detailed description and claims when considered in connection with the Figures, wherein like reference numbers refer to similar elements throughout the Figures, in which:

FIG. 1 shows a block diagram of a data communication system according to aspects of the present disclosure.

FIG. 2 is a block diagram of a system that can implement part or all of one or more aspects or processes of systems to implement a web-native bridge according to embodiments of the present disclosure.

FIG. 3 is a block diagram illustrating a web-native bridge architecture according to aspects of the present disclosure.

FIG. 4 is an illustration of a mobile phone device in which HTTP code is used to access native functionalities of the device according to aspects of the present disclosure.

FIG. 5 is a listing of examples of HTTP code for accessing additional features and functionalities of a mobile device using web-native bridge according to aspects of the present disclosure.

FIG. 6 is a process flow diagram illustrating a method for accessing native features of a mobile device according to aspects of the present disclosure.

### DETAILED DESCRIPTION

Computer systems may be coupled together in various ways to enable communications between them, including being coupled together in networks such as local area networks (LANs), wide area networks (WANs), or combinations of networks, such as the Internet and world wide web. Data may be transferred (e.g., copied or moved) between computer systems in various ways. For instance, an application executing at a first computer system may generate a query, which is a request for particular data. The query may be transmitted to a second computer system, which contains or has access to a data source containing the desired data. The second computer system responds to the query by transmitting the requested data to the first computer system.

Representational state transfer (REST) principles, also referred to as RESTful principles, refer to architectural principals with which applications and services are being developed with a common set of characteristics that are similar to those that enable the scale of the World Wide Web. These characteristics include the use of REST interfaces for accessing resources, a URI (Uniform Resource Identifier) namespace that identifies the resources, simple payload formats or representations, and a stateless request-response interaction model. Applications and services that adhere to the principles of REST enable web-based data sources to be accessed in a more efficient manner.

Aspects of the present disclosure include a hypertext transfer protocol (HTTP) web-native bridge that exposes native modules of a mobile device to hybrid mobile applications via a web service. The web-native bridge may be implemented as a local integrated HTTP server and embraces the principles of HTTP and REST to enable access to native capabilities of a device by using standard web universal resource locators (URLs). The HTTP web-native bridge includes a platform independent framework for developing hybrid mobile applications without using a platform-specific software development kit (SDK) or a client application programming interface (API). The disclosed framework includes a fully featured HTTP web server that is configured to function as a proxy for routing requests from web-based user interfaces to native device context. This enables web developers using familiar web technologies and a complete HTTP feature set to directly interface with native capabilities of a mobile device such as camera, global positioning system (GPS) and other device sensors, for example.

By observing REST principles, client browsers and servers can interact in complex ways without the client browser knowing anything beforehand about the server and the resources/services it hosts.

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

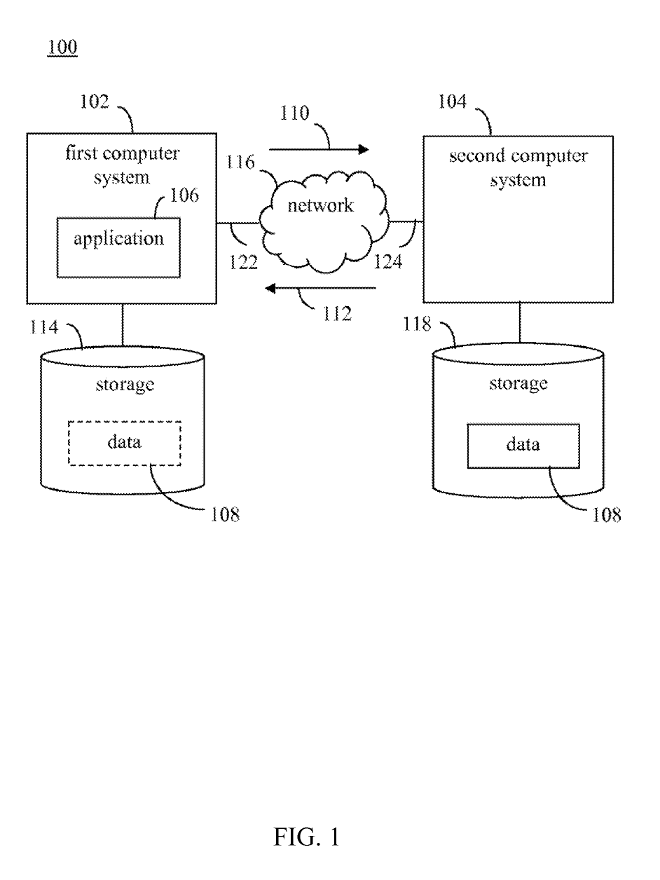

Aspects of the present disclosure relate to data communications in distributed systems. For example, FIG. 1 shows a block diagram of a data communication system 100, according to an example embodiment. As shown in FIG. 1, system 100 includes a first computer system 102, a second computer system 104, a first storage 114, a network 116, and a second storage 118. An application 106 executes in first computer system 102. Storage 114 is coupled to first computer system 102. Storage 118 is coupled to second computer system 104. First and second computer systems 102 and 104 are communicatively coupled by network 116. System 100 is configured to enable resources to be transferred between first and second computer systems 102 and 104.

First and second computer systems 102 and 104 may each be any type of computing device, including a desktop computer (e.g., a personal computer), a server, a mobile computer or computing device such as a smart phone or tablet computer device, a personal digital assistant (PDA), a laptop computer, a notebook computer, etc., or other type of computer system. Storage 114 and storage 118 may each include one or more of any type of storage mechanism to store content (e.g., objects), including a hard disk drive, an optical disc drive, a memory device such as a RAM device, a ROM device, etc., and/or any other suitable type of storage medium.

Network 116 may include one or more communication links and/or communication networks, such as a LAN (local area network), a WAN (wide area network), or a combination of networks, such as the Internet. First and second communication links 122 and 124, which respectively couple first and second computer systems 102 and 104 to network 116, may include any number of communication links, including wired and/or wireless links, such as IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB links, etc.

Application 106 may issue a query for a resource (e.g., data). The resource may be accessible as data 108 contained in storage 118 at second computer system 104. To obtain the resource, first computer system 102 may transmit the query from first computer system 102 in a first communication signal 110. For example, first computer system 102 may contain an agent (e.g., a “client” agent) configured to handle transmission of queries. First communication signal 110 is transmitted through a first communication link 122, network 116, and a second communication link 124, and is received by second computer system 104. First communication signal 110 may be transmitted in any form, including in the form of a stream of packets (e.g., IP packets).

Second computer system 104 processes the request received in first communication signal 110. For example, second computer system 104 may include an agent (e.g., a “server” agent) configured to process received queries. Second computer system 104 retrieves data 108 from storage 118, which may contain a database or other data source. Second computer system 104 generates a second communication signal 112, which is a response signal that includes data 108. Second communication signal 112 is transmitted through second communication link 124, network 116, and first communication link 122, and is received by first computer system 102. Application 106 receives data 108 included in second communication signal 112, which may be stored in storage 114 (as indicated by dotted lines in FIG. 1). Second communication signal 112 may be transmitted in any form, including in the form of a stream of packets (e.g., IP packets).

Currently, applications and services are being developed that include the use of REST (representational state transfer) interfaces for accessing resources and a URI (Uniform Resource Identifier) namespace that identifies the resources. These applications and services enable web-based data sources to be accessed in a more efficient manner. For example, second computer system 104 in FIG. 1 may be configured to have a REST interface to enable data 108 to be accessed according a URI.

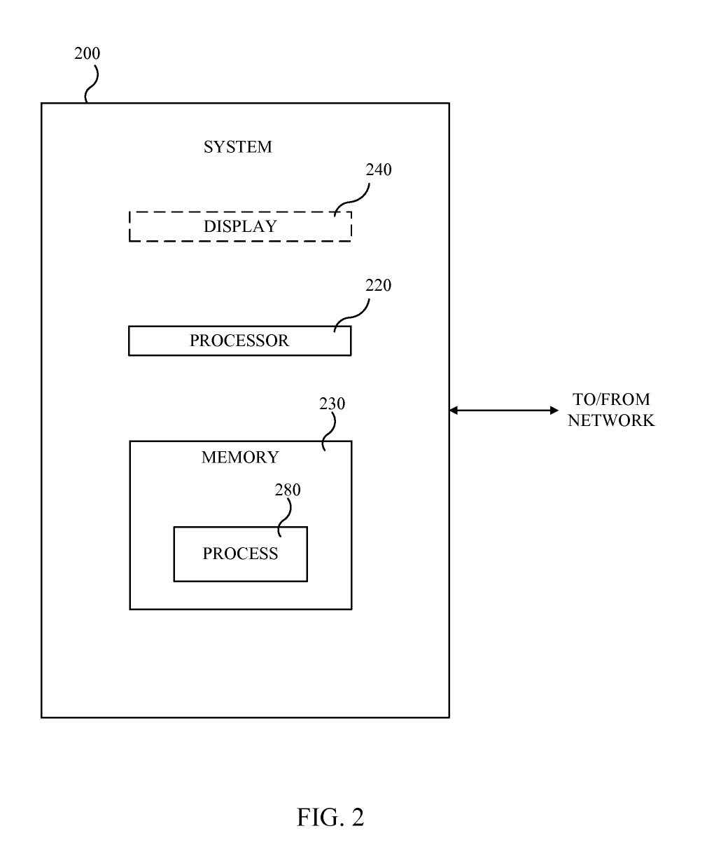

FIG. 2 is a block diagram of a system 200 that can implement part or all of one or more aspects or processes of systems within which a web-native bridge according to embodiments of the present disclosure can operate or within which methods according to embodiments of the present disclosure can be carried out. As shown in FIG. 2, memory 230 configures the processor 220 to implement one or more aspects of the methods, steps, and functions disclosed herein (collectively, shown as process 280 in FIG. 2). Different method steps can be performed by different processors. The memory 230 could be distributed or local and the processor 220 could be distributed or singular. The memory 230 could be implemented as an electrical, magnetic or optical memory, or any combination of these or other types of storage devices. It should be noted that if distributed processors are employed, each distributed processor that makes up processor 220 generally contains its own addressable memory space. It should also be noted that some or all of computer system 200 can be incorporated into an application-specific or general-use integrated circuit. For example, one or more method steps could be implemented in hardware in an ASIC rather than using firmware. Display 240 is representative of a variety of possible input/output devices (e.g., displays, touchscreens, mice, keyboards, and so on).

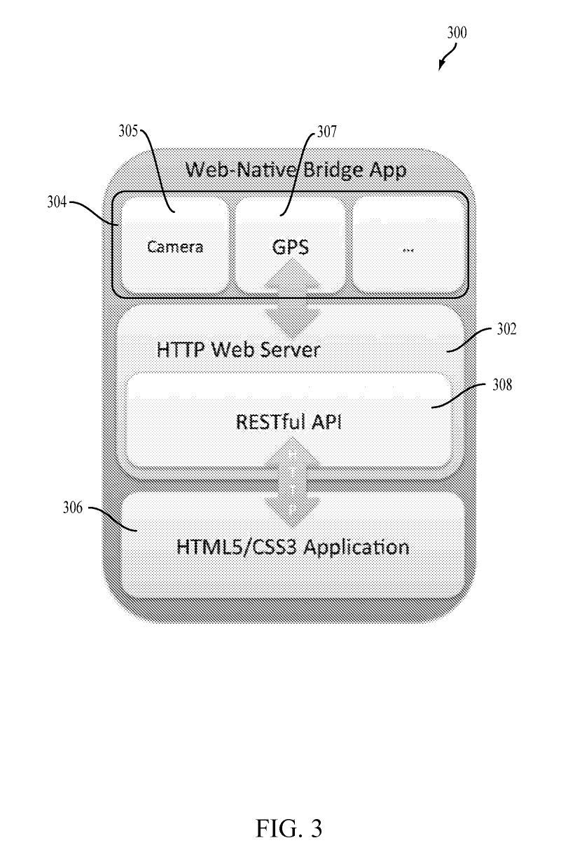

A web-native bridge architecture according to aspects of the present disclosure is described with reference to FIG. 3. The web native bridge architecture 300 provides a fully featured HTTP web server that is configured to function as a glue layer between a web application 306 and the hardware of a particular mobile device 304, such as an iPhone or Android device, for example.

The web native bridge architecture 300 includes a web server 302 and a RESTful API 308 configured on the web server 302. The web server 302 may be a standard HTTP web server such as an Apache web server or Nginx (pronounced engine-x) web server, which are well known open source web servers, for example. The RESTful API 308 is coupled in communication with a native code module that is maintained to include native code for interacting with the features and functionalities of commonly available mobile devices. The RESTFul API 308 is also coupled in communication with a web application 306. The features and functionalities 304 of a mobile device that are accessible via the RESTful API are coupled in communication with the web server 302, and may include native hardware components such as a camera 305, GPS 307 and/or other native features of the device, for example.

Communication between the web application 306 and the RESTful API 308 may be entirely performed using HTTP, in which the web application 306 is a client of the web server 302. The use of HTTP to communicate with the RESTful API 308 allows web developers to easily develop hybrid applications without directly including native code.

According to aspects of the present disclosure, the web server 302 starts when a web application 306 starts and stops when the web application 306 terminates. The web server 302 listens on an arbitrary port for requests for native device functionality that it can route through its RESTful API 308. Examples of such requests include requests to take a picture or requests for GPS information, for example. The server 306 is configured to recognize requests by the web application 306 that may be implemented on the device using native code from the native code module 308. In response to recognizing such a request, the web server 302 retrieves the appropriate native code from the native code module 308 and executes the native code to access the requested feature or functionality of the mobile device.

Table 1 below shows examples of other REST endpoints that provide access to native device functionality.

TABLE 1
/native

| | | |
|---|---|---|
| GET | /native/camera/pick | Pick an image from the camera |
| GET | /native/camera/roll/{image-id} | Return image from camera roll |
| GET | /native/modal/create | Create a Modal window |
| GET | /native/email/create | Show the email compose window |

In one example, an application that integrates the web-native bridge may invoke a camera functionality of a mobile device by simply calling the following URL:
http://localhost:1306/native/camera/pick?quality=50&callback=imagePicked.

In another example, the following code achieves picking an image with the camera using JQuery as a utility library:

// bind camera action to element with class ‘button’
$(“.button”).on(“touchend”,function(e) {
$.get(“/native/camera/pick”, {quality: 50, callback: “imagePicked”});
});
// callback
function imagePicked(image) {
$(“.composeArea”).append(‘<img src=”/native/camera/roll/’ +
image.filename + ‘”/>’);
}

According to aspects of the present disclosure, multiple web applications can access the server 302 of the web-native bridge architecture 300 at the same time. The RESTful API 308 allows the multiple applications to freely exchange information and state. For example, when multiple applications access the RESTFul API, one application is able to send a notification to another application and both applications are able to use the same state information, such as login session information or an analytics component.

According to aspects of the present disclosure, the standard web server 302 may run locally on a mobile device. Standard HTTP requests in the web application code runs on the standard web server 302 of the web-native bridge architecture 300 to request access to some native functionality of the device. In contrast to previous tools for bridging web applications to native device functionality, the disclosed web-native bridge architecture is based on existing HTTP web standards and allows web developers to access native features and functionalities of a device without learning a new API or including additional libraries in their web applications.

The disclosed web-native bridge is implemented by pre-constructing, native code modules from other libraries code for providing access to numerous features and functionalities of commonly used mobile devices. According to aspects of the present disclosure, the native code modules are made available to web developers at a high level via the RESTful API 308. The web native bridge accesses the pre-written native code modules in response to standard HTTP requests in a web application. The disclosed web-native bridge server may be accessed as a web service by web developers to access particular features of a mobile device without including additional libraries in the web application code, without learning an API and without learning the native code.

For example, according to aspects of the present disclosure, a developer may use familiar HTTP code and the disclosed web-native bridge to access the microphone or camera on a mobile device without learning the device native code. To develop an application that uses the microphone or camera of a mobile device, for example, a developer can simply call on the web native bridge server 302 using an HTTP request to request microphone or camera support.

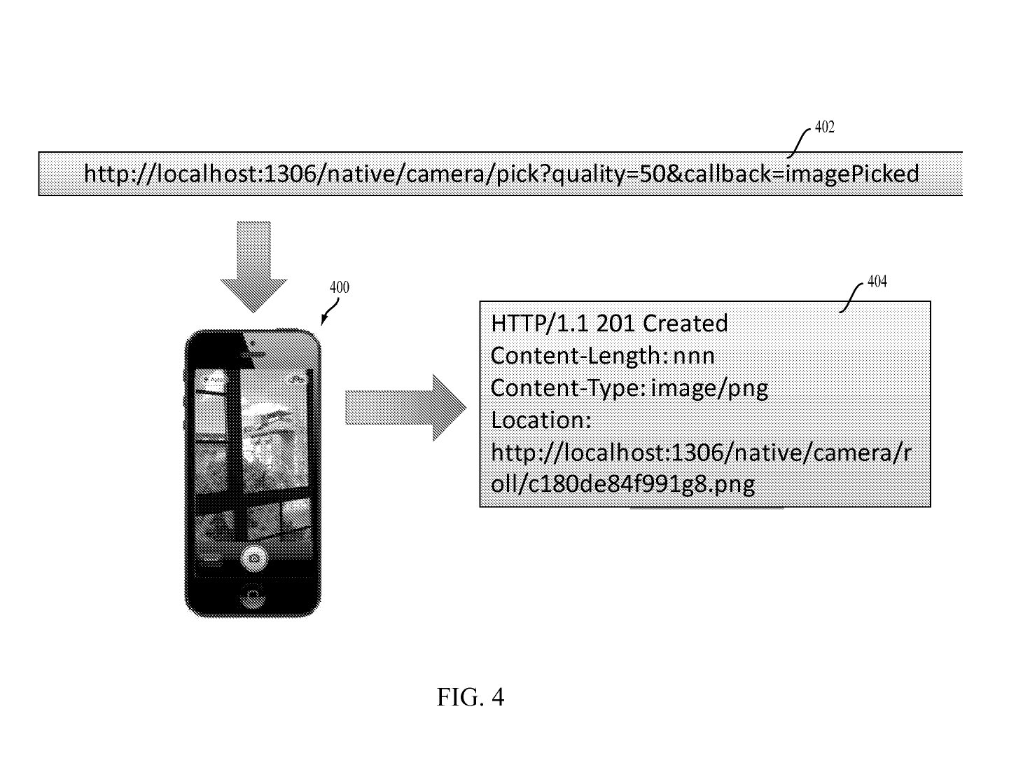

Referring to FIG. 4, one example use of the web native bridge facilitates picking an image from the camera of a mobile phone device 400. An HTTP request 402 for an image to be picked from a camera of the mobile phone device 400 is communicated by a web application to a web-native bridge server running on the mobile phone device. The web-native bridge server recognizes the HTTP request as a request for access to a native functionality of the device and, in response selects appropriate native code from a native code module, and executes the native code to implement the requested service. The web-native bridge server then sends an appropriate HTTP response 404 to the web application including an output from the requested service, which in this example is a URI of the requested image.

The following JQuery code is an example of familiar high level code that may be used by a web developer for picking the image as shown in FIG. 4:

```
// bind camera action to element with class ‘button’
$(“.button”).on(“touchend”, function(e) {
  $.get(“/native/camera/pick”, {quality: 50, callback: “imagePicked”});
});
// callback
function imagePicked(image) {
  $(“.composeArea”).append(‘<img src=”/native/camera/roll/’ +
  image.filename + ‘”/>’);
}
```

The following HTML and Java Script code is another example of familiar high level code that may be used by a web developer for picking the image as shown in FIG. 4:

```
<a href=”/native/camera/pick?quality=50&callback=imagePicked”>Pick an
image!</a>
<script>
  function imagePicked(info) {
    // do something with the info object
  }
</script>
```

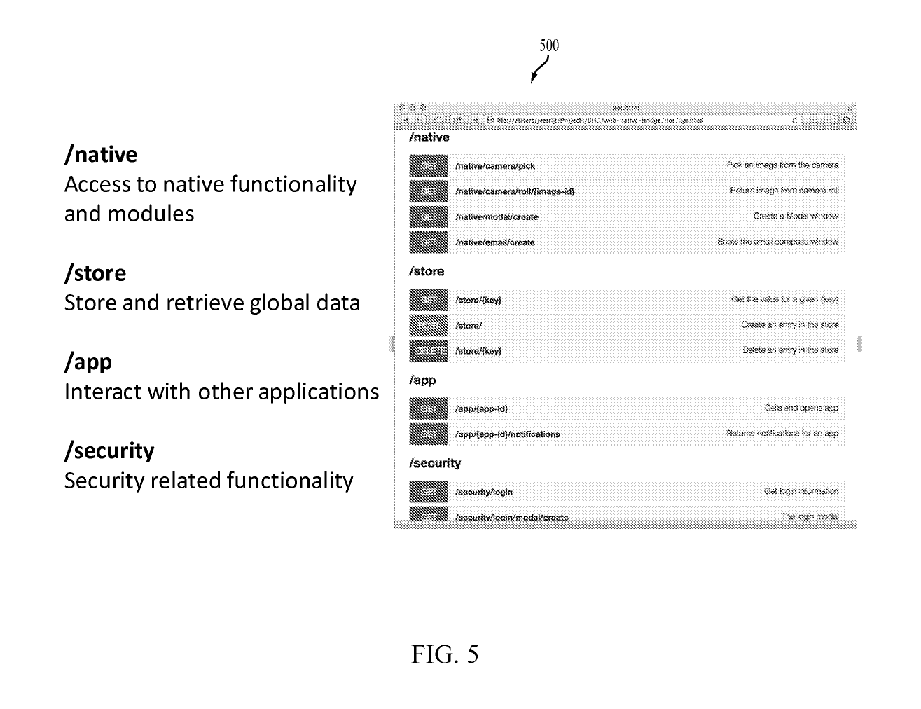

FIG. 5 shows examples of HTTP code 500 for accessing additional features and functionalities of a mobile device using a web-native bridge according to aspects of the present disclosure.

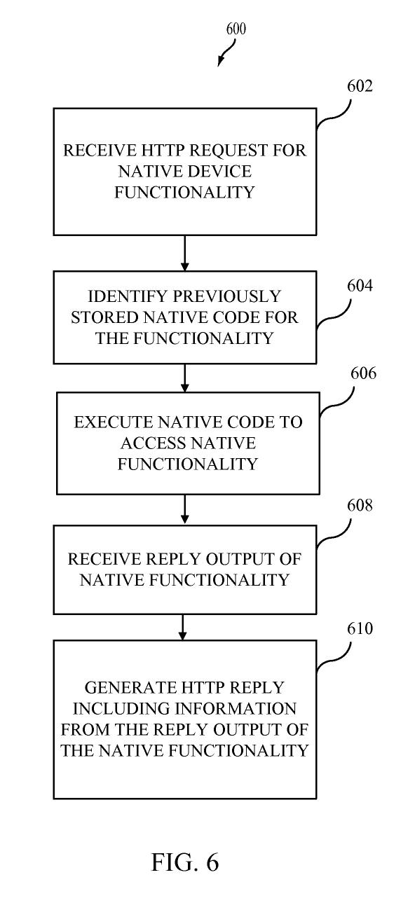

FIG. 6 is a process flow diagram describing a method 600 for accessing native features of a mobile device according to aspects of the present disclosure. At block 602, the method includes receiving a hypertext transfer protocol (HTTP) request from a client application for access to a native feature of the computing device by an HTTP server. At block 604, the method includes identifying a previously stored native code by the HTTP server in response to receiving the HTTP request. According to aspects of the present disclosure, the identified previously stored native code is executable by the computing device to access the native feature. At block 606, the method includes executing the previously stored native code on the device to access the native feature. At block 608, the method includes receiving a reply of the native feature by the server, and at block 610, the method includes generating an HTTP reply by the HTTP server. The HTTP reply includes information contained in the reply of the native feature.

The disclosed web-native bridge simplifies building and interacting with native modules and native capabilities of a mobile device. The web-native bridge may be implemented quickly based on principles of HTTP for ease of use and a short learning curve. To simplify and optimize working with resources, resources are retrieved locally from a single repository. A common platform, which is shared between applications, enables interaction between many disparate applications, enforcement of user interface standards, and reuse of common components, such as security or analytics for example. The common platform also provides state information and interconnectivity between multiple disparate environments.

The terms “computer program medium” and “computer usable medium” are used to generally refer to media such a as removable storage drive and a hard disk installed in a hard disk drive. These computer program products provide software to a computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into a computer system using removable storage drive, hard disk drive or communications interface. The control logic (software), when executed by the processor, causes the processor to perform the functions of various embodiments as described herein. In various embodiments, software may be implemented in hardware components such as application specific integrated circuits (ASICs). Implementation of the hardware state machine so as to perform the functions described herein will be apparent to persons skilled in the relevant art(s).

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

The computers discussed herein may provide a suitable website or other Internet-based graphical user interface which is accessible by users. In various embodiments, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In various embodiments, the Apache web server is used in conjunction with a Linux operating system, a MySQL database, and the PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, AJAX, WSDL and UDDI, Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more”.

Although illustrative embodiments of the present disclosure have been described herein with reference to the accompanying drawings, it is to be understood that the present disclosure is not limited to those precise embodiments, and that various other changes and modifications may be made by one skilled in the art without departing from the scope or spirit of the disclosure.

What is claimed is:

1. A method for accessing native features of a computing device, comprising:
receiving a hypertext transfer protocol (HTTP) request from a client application for access to a native feature of the computing device by an HTTP server;
identifying a previously stored native code by the HTTP server in response to receiving the HTTP request, the identified previously stored native code being executable by the computing device to access the native feature;
executing the previously stored native code on the device to access the native feature;
receiving a reply of the native feature by the server; and
generating an HTTP reply by the HTTP server, the HTTP reply including information contained in the reply of the native feature.

2. The method of claim 1, further comprising:
communicating the HTTP reply from the HTTP server to the client application.

3. The method of claim 1, comprising:
initiating operation of the HTTP server on the computing device when the client application begins execution;
monitoring a port of the HTTP server for HTTP requests to access native features of the computing device that correspond to previously stored native code; and
terminating operation of the HTTP server on the computing device when the client application ends execution.

4. The method of claim 1, further comprising:
communicating the identified previously stored native code by the server to a native process of the computing device for executing on the computing device.

5. The method of claim 1, further comprising:
receiving the hypertext transfer protocol (HTTP) request by a RESTful application programming interface on the HTTP server.

6. The method of claim 5, further comprising:
communicating state information from a first client application to a second client application via the RESTful application programming interface.

7. The method of claim 1, further comprising:
storing a plurality of native code modules in memory that is accessible by the HTTP server, the plurality of native code modules corresponding to respective native features of the computing device that are not directly accessible by HTTP requests.

8. A method for accessing native features of a mobile computing device, comprising:
sending a hypertext transfer protocol (HTTP) request to an HTTP server on a mobile computing device, the HTTP request requesting access to a native feature of the mobile computing device; and
receiving an HTTP reply from the HTTP server, the HTTP reply generated by the HTTP server and including information contained in a reply of the native feature in response to implementation of the native feature.

9. The method of claim 8, further comprising:
sending the hypertext transfer protocol (HTTP) request to a RESTful application programming interface on the HTTP server.

10. The method of claim 9, further comprising:
communicating state information to a second client application via the RESTful application programming interface.

11. An apparatus for accessing native features of a computing device, comprising:
means for receiving a hypertext transfer protocol (HTTP) request from a client application for access to a native feature of the computing device;
means for identifying a previously stored native code in response to receiving the HTTP request, the identified previously stored native code being executable by the computing device to access the native feature;
means for executing the previously stored native code on the device to access the native feature;
means for receiving a reply of the native feature by the server; and
means for generating an HTTP reply, the HTTP reply including information contained in the reply of the native feature.

12. The apparatus of claim 11, further comprising:
means for communicating the HTTP reply to the client application.

13. The apparatus of claim 11, comprising:
means for initiating operation of an HTTP server on the computing device when the client application begins execution;
means for monitoring a port of the HTTP server for HTTP requests to access native features of the computing device that correspond to previously stored native code; and
means for terminating operation of the HTTP server on the computing device when the client application ends execution.

14. The apparatus of claim 11, further comprising:
means for communicating the identified previously stored native code by the server to a native process of the computing device for executing on the computing device.

15. The apparatus of claim 11, further comprising:
means for receiving the hypertext transfer protocol (HTTP) request by a RESTful application programming interface on an HTTP server.

16. The apparatus of claim 15, further comprising:
means for communicating state information from a first client application to a second client application via the RESTful application programming interface.

17. The apparatus of claim 11, further comprising:
means for storing a plurality of native code modules in memory that is accessible by the HTTP server, the plurality of native code modules corresponding to respective native features of the computing device that are not directly accessible by HTTP requests.

18. An apparatus for accessing native features of a mobile computing device, comprising:
a server configured for receiving a hypertext transfer protocol (HTTP) request from a web client application for access to a native feature of the mobile computing device, the server including a RESTful application programming interface;
memory in communication with the server and storing previously written native code on the mobile computing device to access the native feature;
a native process of the device in communication with the server and configured to execute the native code to implement the native feature.

19. The apparatus of claim 18, wherein the server is further configured:
to receive a reply of the native process; and
to communicate a HTTP response to the web client application based on the reply.

20. The apparatus of claim 18, further comprising a library of previously written code for accessing native features on a plurality of mobile computing device platforms.
